(19) United States
(12) Patent Application Publication
(10) Pub. No.: US 2026/0287245 A1
(43) Pub. Date: Sep. 24, 2026

(54) REFRIGERATOR

(71) Applicant: LG Electronics Inc., Seoul (KR)

(72) Inventors: Wonsang CHOI, Seoul (KR); Seungjin YOON, Seoul (KR)

(21) Appl. No.: 19/490,220

(22) PCT Filed: Jul. 30, 2024
(86) PCT No.: PCT/KR2024/011112

§ 371 Date: Dec. 4, 2025

(30) Foreign Application Priority Data
Aug. 3, 2023 (KR) 10-2023-0101801

(51) Int. Cl. F25D 23/02; E05B 65/00

(52) U.S. Cl. CPC F25D 23/025; E05B 65/0042; F25D 2323/021; F25D 2323/023; F25D 2700/02

(57) ABSTRACT

A refrigerator according to the present embodiment comprises: a cabinet provided with a storage chamber; a first door which opens/closes the storage chamber and has an opening; a second door which opens/closes the opening and is rotatable with respect to the first door; a locking device which allows the first door and the second door to be in a locked state or a released state while the second door is closed; a door opening device for automatically opening the second door; and a controller controlling the door opening device.

### TECHNICAL FIELD

The present disclosure relates to a refrigerator.

### BACKGROUND ART

In general, a refrigerator is a home appliance for storing food at a low temperature in a storage space that is covered by a door.

The storage space is surrounded by an insulating wall so that an inside of the storage space is maintained at a temperature lower than an outside temperature. Depending on a temperature range of the storage space, the storage space may be called as a refrigerating chamber or a freezing chamber.

In order to put an object into the storage space or take it out from the storage space, the user opens the door. Generally, the door is rotatably connected to the cabinet, and a gasket is provided between the door and the cabinet. Therefore, when the door is closed, the gasket is tightly sealed between the door and the cabinet, preventing cold air from leaking out of the storage space. As a sealing force of the gasket increases, an effect of preventing cold air from leaking out can be increased.

In order to increase the sealing force of the gasket, the gasket may be formed of a rubber magnet, and a magnet may be provided inside the gasket. However, if the sealing force of the gasket increases, a large force is required when opening the door.

Therefore, refrigerators with an automatic door opening function have been provided recently.

A refrigerator is disclosed in Korean Patent Publication No. 10-2018-0119027 that is a prior art document.

A refrigerator of the prior art document includes a cabinet having at least one storage space therein, a door arranged at one side of the cabinet to open and close the storage space, and a door opening device that moves the door so that the storage space is opened by a driving force of a motor.

Specifically, the door may include an inner door that is in close contact with a front surface of the cabinet, and an outer door arranged at a front side of the inner door.

The door opening device is provided in the cabinet, and pushes the inner door to open the inner door.

However, in a case of the prior art document, since the outer door opens together with the inner door when the inner door is opened, there is a disadvantage that the outer door cannot be opened automatically.

In addition, in the case of the prior art document, since the door opening device is provided in the cabinet, if the outer door is to be opened using the door opening device, there is a disadvantage that a length of the door opening device increases and a structure becomes complicated in order to push the outer door without interfering with the inner door.

### DISCLOSURE

### Technical Problem

One embodiment provides a refrigerator in which a second door is disposed outside a first door and a second door can be automatically opened.

Alternatively or additionally, one embodiment provides a refrigerator in which a coupled state of the first door and the second door is maintained when the first door is opened.

Alternatively or additionally, one embodiment provides a refrigerator in which left and right doors are provided and a second door of each of the left and right doors can be automatically opened independently.

Alternatively or additionally, one embodiment provides a refrigerator capable of manual opening of a second door while a power supply to the refrigerator is cut off.

### Technical Solution

A refrigerator according to one aspect may include a cabinet having storage space.

The refrigerator may further include a first door that opens and closes the storage space and including an opening. The refrigerator may further include a second door that opens and closes the opening and is rotatable relative to the first door. The refrigerator may further include a locking device that allows the first door and the second door to be in a locking state or an unlocking state in a state in which the second door is closed.

The refrigerator may further include a door opening device to automatically open the second door. The refrigerator may further include a controller to control the door opening device.

The locking device may include a locking portion provided at the first door. The locking portion may be inserted into the second door.

The second door may include a latch portion that is hooked with the locking portion in a state in which the locking portion is positioned at a locking position. The second door may further include a manipulating portion to move the latch portion to an unhooking position where the latch portion is unhooked from the locking portion.

The second door may include a handle. The manipulating portion may be exposed to the handle.

When the handle is pulled in a locking state of the first door and the second door, the first door can be opened. When the handle is pulled after operating the manipulating portion in the locking state of the first door and the second door, the second door can be opened. When the handle is pulled in an unlocking state of the first door and the second door, the second door can be opened.

The second door may include a groove into which the locking portion is inserted at a locking position of the locking portion. The latch portion may form a portion of the groove, or a portion of the latch portion may cover the groove in a state in which the latch portion is hooked with the locking portion.

In a state in which the locking portion is positioned at the locking position, when the manipulating portion is manipulated in one direction, the latch portion may be rotated in a first direction and moved to the unhooking position.

The locking portion may include a recess.

The latch portion may include a hook portion to be hooked with the locking portion. A protrusion may be formed on the hook portion to be inserted into the recess.

When the latch portion moves to the unhooking position, the protrusion may be withdrawn from the recess, and the latch portion may be spaced apart from the locking portion.

An inclined surface may be formed at an opposite side of the protrusion in the hook portion. An inclined portion may be formed at an opposite side of the recess in the locking portion.

The latch portion may include a first portion in which a hook portion to be hooked with the locking portion is formed, and a second portion extending from the first portion and rotatably supported by the second door.

The second door may include a receiving portion that receives a portion of the first portion. A slot through which the second portion passes may be formed in the receiving portion.

The first portion may include a first inclined surface received in the receiving portion, and at least a portion of the first inclined surface may be spaced apart from a recessed surface of the receiving portion in a state in which the hook portion is hooked with the locking portion.

While the latch portion moves to the unhooking position, the first inclined surface may move closer to the recessed surface.

The first portion may further include a second inclined surface positioned outside the receiving portion. A distance between the first and second inclined surfaces may decrease downward.

The locking device may further include a first driver.

The locking portion may be operated by receiving a power from the first driver. The first door may be provided with a hole through which the locking portion passes. The locking portion may be inserted into a groove of the second door by passing through the hole.

The second door may include an extension positioned in the opening when the second door is closed. The extension may be provided with the latch portion and a groove into which the locking portion is inserted.

In a state in which the latch portion is hooked with the locking portion, the locking portion may be positioned between a portion of the latch portion and a front surface of the second door.

The refrigerator may further include an input detection portion that detects an input of an opening command for the second door.

When the input detection portion detects an input of an opening command for the second door, the locking device may be controlled so that the first door and the second door are in an unlocking state. The controller may operate the door opening device to open the second door when the first door and the second door are in an unlocking state.

The refrigerator may further include a door opening and closing detection portion that detects a closing of the second door. When the closing of the second door is detected by the door opening and closing detection portion, the locking device may be controlled so that the first door and the second door are in a locking state.

The door opening device may include a second driver, and a door opening portion that operates by receiving power from the second driver and pushes the first door or the second door during an opening process of the second door.

### Advantageous Effects

According to one embodiment, there is an advantage in that automatic opening of a second door disposed at an outside of a door is possible when a door includes a first door and a second door.

According to one embodiment, when an input detection portion is activated when a proximity of a user is detected, there is an advantage in that unnecessary activation of the input detection portion is prevented.

According to one embodiment, when a second door is closed, the second door and the first door are in a locking state, so there is an advantage in that an opening of the first door is possible.

According to one embodiment, since a handle for opening the first door is the same as a handle for opening the second door, there is an advantage in that two separate handles are unnecessary.

According to one embodiment, even when a power supplied to a refrigerator is cut off, such as a power outage, etc., there is an advantage in that a second door can be manually opened by manipulating a manipulating portion.

According to one embodiment, there is an advantage in that manual opening of the second door is possible by operating the manipulating portion even if the locking device is broken or malfunctions.

### DESCRIPTION OF DRAWINGS

FIG. 1 is a front view of a refrigerator according to an embodiment of the present invention.

FIG. 2 is a drawing showing a state in which a second door is opened in a refrigerating chamber door according to an embodiment of the present invention.

FIG. 3 is a drawing showing a state in which a refrigerating chamber door and a freezing chamber door are opened according to an embodiment of the present invention.

FIG. 4 is a drawing showing a state in which a second door is opened while a first door is closed according to an embodiment of the present invention.

FIG. 5 is a cross-sectional view taken along line 5-5 of FIG. 1.

FIG. 6 is a cross-sectional view taken along line 6-6 of FIG. 1.

FIG. 7 is a drawing partially showing a state in which a second door is opened according to an embodiment of the present invention.

FIG. 8 is a drawing showing a door opening device provided in the second door.

FIG. 9 is a plan view showing a state in which a door opening portion protrudes from a second door.

FIG. 10 is a drawing showing a position of a door opening device in a second door.

FIG. 11 is a drawing showing a door opening device and an auto closing unit in a second door.

FIG. 12 is a perspective view of the locking portion of the present embodiment.

FIG. 13 is a drawing showing a second door viewed from a lower side in a state in which first and second doors are closed.

FIG. 14 is a perspective view showing a latch portion provided at an extension of a second door.

FIG. 15 is a perspective view showing a latch portion removed from an extension of a second door.

FIG. 16 is a drawing showing a latch portion and manipulating portion installed at the second door.

FIG. 17 is a drawing showing a state in which a manipulating portion is installed at the second door.

FIG. 18 is a perspective view of a manipulating portion according to the present embodiment.

FIG. 19 is a perspective view of a latch portion according to the present embodiment.

FIG. 20 is a drawing showing a state of a latch portion, a locking portion, and a manipulating portion when the latch portion is positioned at an initial position.

FIG. 21 is a drawing showing a state when a manipulating portion is manipulated and a latch portion is moved to an unhooking position.

FIG. 22 is a control block diagram of a refrigerator according to an embodiment of the present invention.

FIG. 23 is a diagram showing a state in which an input detection portion is activated when a user approaches a refrigerator within a reference distance.

FIG. 24 is a drawing showing a user inputting a door opening command into an input detection portion.

FIG. 25 is a drawing showing first and second doors being unlocked by a locking device.

FIG. 26 is a drawing showing a state in which a second door is opened by a door opening device at a door opening angle.

### MODE FOR INVENTION

Hereinafter, some embodiments of the present disclosure will be described in detail with reference to the accompanying drawings. It should be noted that when components in the drawings are designated by reference numerals, the same components have the same reference numerals as far as possible even though the components are illustrated in different drawings. Further, in description of embodiments of the present disclosure, when it is determined that detailed descriptions of well-known configurations or functions disturb understanding of the embodiments of the present disclosure, the detailed descriptions will be omitted.

Also, in the description of the embodiments of the present disclosure, the terms such as first, second, A, B, (a) and (b) may be used. Each of the terms is merely used to distinguish the corresponding component from other components, and does not delimit an essence, an order or a sequence of the corresponding component. It should be understood that when one component is “connected”, “coupled”, “joined” to another component, the former may be directly connected, coupled, or jointed to the latter or may be “connected”, coupled”, or “joined” to the latter with a third component interposed therebetween.

In this specification, a front surface of a second door is a surface forming a front exterior of the refrigerator door, and a rear surface of a second door is a surface facing a first door.

A front surface of a first door is a surface forming a front exterior of the first door and facing a rear surface of the second door. A rear surface of the first door is a surface facing a cabinet or a storage space.

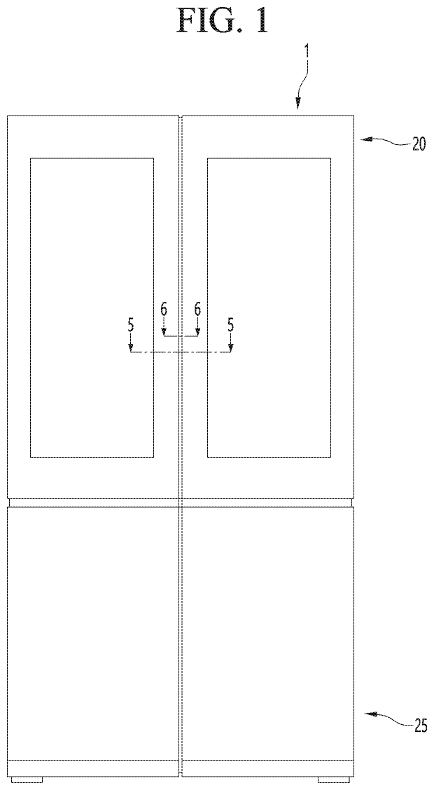

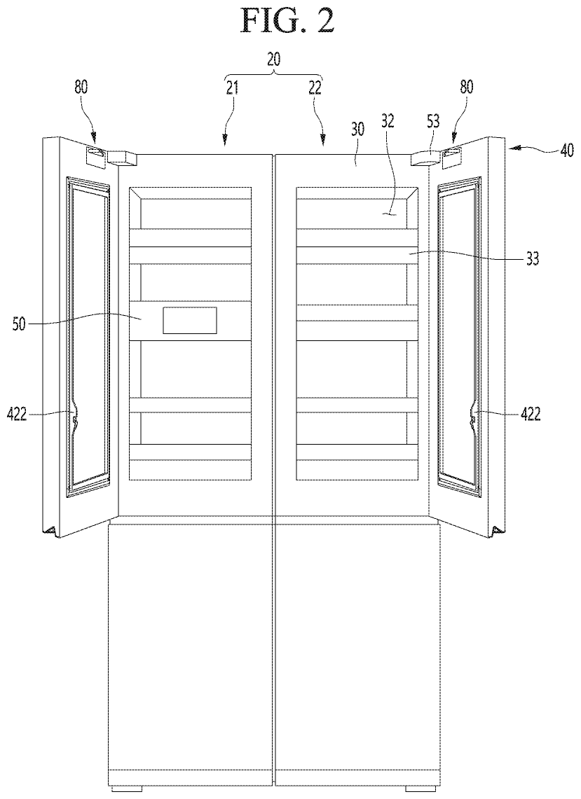

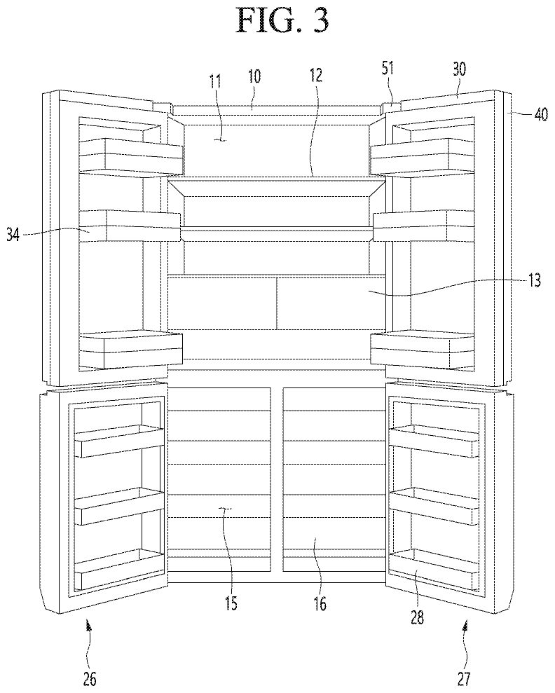

FIG. 1 is a front view of a refrigerator according to an embodiment of the present invention. FIG. 2 is a drawing showing a state in which a second door is opened in a refrigerating chamber door according to an embodiment of the present invention. FIG. 3 is a drawing showing a state in which a refrigerating chamber door and a freezing chamber door are opened according to an embodiment of the present invention.

Referring to FIGS. 1 to 3, a refrigerator 1 according to an embodiment of the present invention may include a cabinet 10 that forms a storage space. The refrigerator may further include a door that opens and closes the storage space.

The storage space may include, for example, at least one of a refrigerating chamber 11 or a freezing chamber 15. Although not limited, the refrigerating chamber 11 may be positioned above the freezing chamber 15. Depending on a shape of the refrigerator, the freezing chamber 15 and the refrigerating chamber 11 may be positioned left and right, or the freezing chamber 15 may be positioned at an upper side of the refrigerating chamber 11.

The door may include a refrigerating chamber door 20 that opens and closes the refrigerating chamber 11, and a freezing chamber door 25 that opens and closes the freezing chamber 15.

The refrigerating chamber door 20 may include, for example, a pair of doors 21 and 22 arranged in a left and right direction. That is, the refrigerating chamber door 20 may include a first refrigerating chamber door 21 and a second refrigerating chamber door 22 arranged in a left and right direction. The first refrigerating chamber door 21 may open and close a portion of the refrigerating chamber 11, and the second refrigerating chamber door 22 may open and close another portion of the refrigerating chamber 11.

The freezing chamber door 25 may include, for example, a pair of doors 26 and 27 arranged in a left and right direction. That is, the freezing chamber door 25 may include a first freezing chamber door 26 and a second freezing chamber door 27 arranged in a left and right direction. The first freezing chamber door 26 may open and close a portion of the freezing chamber 15, and the second freezing chamber door 27 may open and close another portion of the freezing chamber 15. Alternatively, the freezing chamber 15 may be partitioned left and right or up and down, and the first freezing chamber door 26 may open and close one partitioned space, and the second freezing chamber door 27 may open and close another partitioned space.

It is to be noted that there is no limitation on a number and an arrangement of the refrigerating chamber door 20 and the freezing chamber door 25 in this present invention.

At least one of the first and second refrigerating chamber doors 26, 27 may include a first door 30 that opens and closes the refrigerating chamber 11, and a second door 40 rotatable with respect to the first door 30.

In FIG. 3, as an example, it is illustrated that each of the first and second refrigerating chamber doors 26, 27 includes the first door 30 and the second door 40.

The first door 30 may be rotatably connected to the cabinet 10 by a first hinge 51. The second door 40 may be rotatably connected to the first door 30 by a second hinge 53.

The first door 30 may include a first opening 32. The second door 40 may cover the first opening 32 at a front side of the first door 30. Alternatively, the second door 40 may be received in the first opening 32 and cover the first opening 32.

The first door 30 may be referred to as an inner door or a main door The second door 40 may be referred to as an outer door or a sub-door.

The first door 30 may include one or more baskets 33, 34. The baskets 33, 34 may be mounted on a rear surface of the first door 30 (a surface facing a refrigerating chamber when the door is closed) or mounted on a surface forming the first opening 32.

A display 50 may be provided on one or more of the first and second refrigerating chamber doors 26, 27. For example, FIG. 2 discloses that the display 50 is provided on the first refrigerating chamber door 21. The display 50 may be mounted at the first door 30. The display 50 may be disposed in a first opening 32 of the first door 30.

In a case in which the first door 30 is provided with a plurality of baskets 33, 34, the display 50 may be positioned higher than a lowest basket and lower than an uppermost basket.

For example, the display 50 may be spaced apart from a lower surface and an upper surface forming the first opening 32 of the first door 30. The display 50 may be operated when an operating condition is satisfied in a state in which the second door 40 is closed. Alternatively, the display 50 may be operated when an opening of the second door 40 is detected.

The display 50 may overlap one basket 34 among the plurality of baskets in a front-back direction. For example, a basket 34 may be mounted on the first door 30 at a rear side of the display 50.

At least one of the first and second freezing chamber doors 26, 27 may include a basket 28. As an example, FIG. 2 illustrates that each of the first and second freezing chamber doors 26, 27 is provided with a basket 28.

Meanwhile, the refrigerating chamber 11 may be provided with at least one shelf 12. The refrigerating chamber 11 may be provided with at least one slidable drawer 13.

The freezing chamber 15 may be provided with at least one slidable drawer 16. The drawers 13, 16 can be omitted.

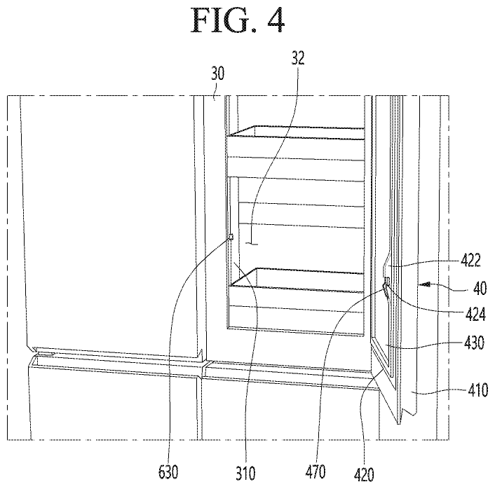

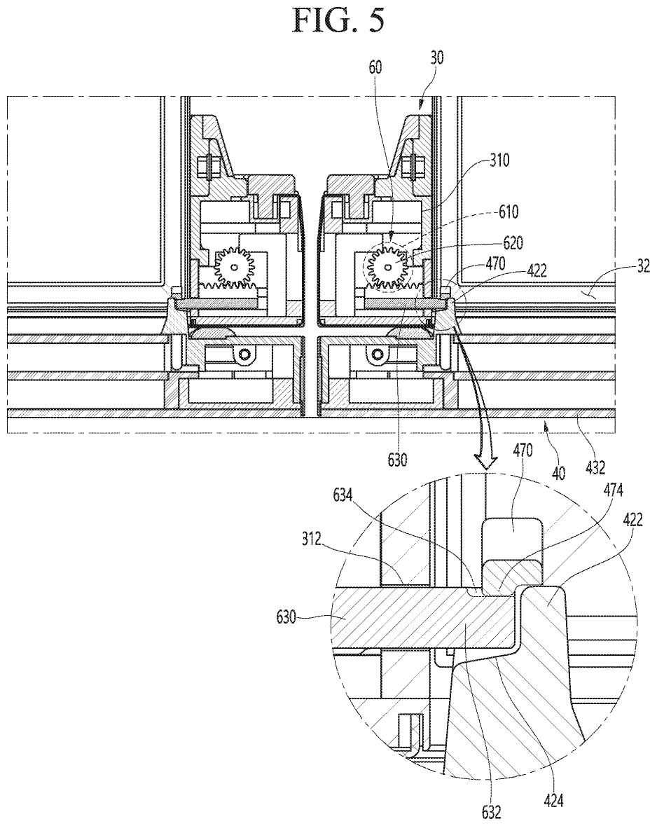

FIG. 4 is a drawing showing a state in which a second door is opened while a first door is closed according to an embodiment of the present invention. FIG. 5 is a cross-sectional view taken along line 5-5 of FIG. 1.

Configurations of a locking device, an input detection portion, a proximity sensor, a door opening and closing detection portion, and a door opening device described below may be applied to either the first refrigerating chamber door 21 and the second refrigerating chamber door 22, or may be applied equally to each.

Referring to FIGS. 4 and 5, the first door 30 may be opened manually or automatically. In a case in which the first door 30 is opened automatically, although not illustrated, a main opening device for opening the first door 30 may be provided at the first door 30 or the cabinet 10.

It is to be noted that a position or structure of a main opening device that opens the first door 30 may apply various technologies previously disclosed by the applicant of the present application. That is, as the first door 30 is opened by the main opening device, the first door 30 and the second door 40 may rotate together.

In a state in which the first door 30 is closed, the second door 40 may be opened independently. In a state in which the second door 40 is closed, the first door 30 may be opened. At this time, while the first door 30 is opened, it is necessary to prevent the second door 40 from rotating relative to the first door 30.

Therefore, in this present embodiment, the refrigerating chamber door 20 may further include a locking device 60 that allows the first door 30 and the second door 40 to be in a locking state or to be in an unlocking state.

The locking device 60 may automatically operate to allow the first door 30 and the second door 40 to maintain a locking state or to be in an unlocking state.

For example, when an opening of the second door 40 is required, the locking device 60 may be operated to allow the second door 40 and the first door 30 to be in an unlocking state. When a closing of the second door 40 is detected after opening, the locking device 60 may be operated to allow the second door 40 and the first door 30 to be in a locking state.

The locking device 60 may include a first driver 610. The first driver 610 may be a motor, for example.

The locking device 60 may further include a transfer portion 620 connected to the first driver 610. The transfer portion 620 may include a gear, for example.

The locking device 60 may further include a locking portion 630 that receives a power of the first driver 610 from the transfer portion 620.

For example, the transfer portion 620 may be a pinion gear, and the locking portion 630 may be a rack including a rack gear engaged with the pinion gear. The locking portion 630 may, for example, move linearly. Of course, depending on a type of the transfer portion 620 or a shape of the locking portion 630, the locking portion 630 may also move in a rotational or curved manner.

The first driver 610, the transfer portion 620, and the locking portion 630 may be provided in the first door 30. Although not shown, the first door 30 may be provided with a foamed insulator for insulation.

The first door 30 is provided with a mounting frame (not shown), and the mounting frame may define an insulating space in which the insulating material is received, and a mounting space in which the first driver 610 is positioned. The first driver 610, the transfer portion 620, and the locking portion 630 may be positioned in the mounting space.

For example, a hole 312 through which the locking portion 630 passes may be formed in a wall 310 forming the first opening 32 in the first door 30.

The locking portion 630 may include a protrusion 632 that passes through the hole 312. In an unlocking state of the first door 30 and the second door 40, the protrusion 632 may be positioned in the hole 312 or inside the first door 30.

Meanwhile, the second door 40 may include a door body. A foamed insulator for insulation may be provided inside the door body.

The door body may include a second opening. The door body may include a body frame 410 and a door liner 420 connected to the body frame 410. The second opening may be formed in a state in which the body frame 410 and the door liner 420 are connected.

The second door 40 may further include a panel assembly 430 that covers the second opening.

The second door 40 may include an extension 422. The extension 422 may extend from a rear surface of the second door 40. For example, the extension 422 may extend from the door liner 420.

In a state in which the second door 40 is closed, the extension 422 may be received in the first opening 32 of the first door 30. A groove 424 may be formed in the extension 422 to receive the protrusion 632.

The second door 40 may further include a latch portion 470. The latch portion 470 may form a portion of the groove 424. Alternatively, the latch portion 470 may cover a portion of the groove 424 in a state in which the locking portion 630 is inserted into the groove 424. Alternatively, the latch portion 470 may be hooked with a protrusion 632 received in the groove 424. While the latch portion 470 is hooked with the protrusion 632, a movement of the latch portion 470 is possible, but a rotation of the second door 40 may be restricted. That is, when the second door 40 is to be rotated while the latch portion 470 is hooked with the protrusion 632, the protrusion 632 restricts a movement of the latch portion 470, and as a result, a rotation of the second door 40 may be restricted.

The latch portion 470 is movable, and the first door 30 and the second door 40 may be in a locking state in a first position (or standby position, or initial position) of the latch portion 470.

At an initial portion of the latch portion 470, when the protrusion 632 is removed from the groove 424, the first door 30 and the second door 40 may be an unlocking state. In an unlocking state, the second door 40 may be rotated with respect to the first door 30. A specific shape and movement of the latch portion 470 will be described later with reference to the drawings.

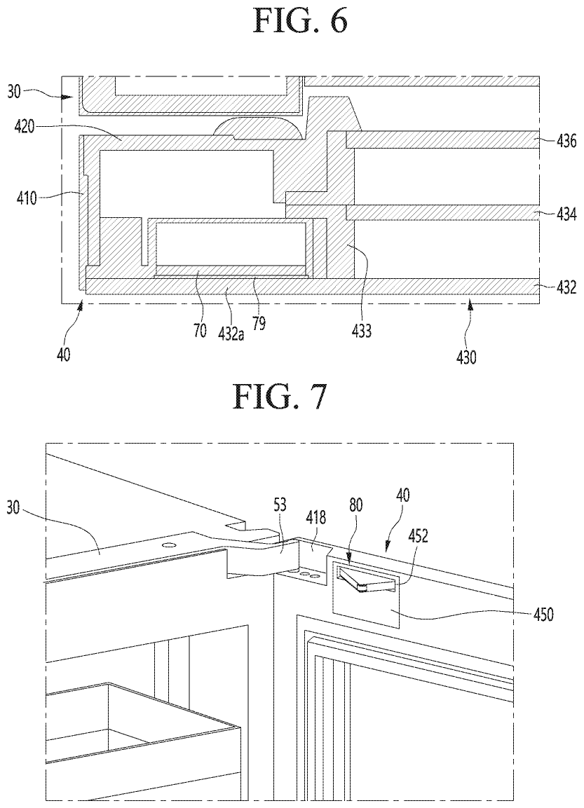

FIG. 6 is a cross-sectional view taken along line 6-6 of FIG. 1.

Referring to FIG. 6, the panel assembly 430 may include a front panel 432 and insulation panels 434, 436 spaced apart from the front panel 432. The front panel 432 and the insulation panels 434, 436 may be spaced apart from each other by a spacer 433.

For example, the insulation panels 434, 436 may include a first panel 434 positioned at a rear side of the front panel 432 and a second panel 436 positioned at a rear side of the first panel 434. A size of the front panel 432 may be greater than a size of the first panel 434. Accordingly, the front panel 432 may include an extension 432a that extends laterally further than the first panel 434.

The body frame 410 may be connected to the front panel 432, and the door liner 420 may be connected to the second panel 436.

The refrigerating chamber door 20 may further include an input detection portion 70. For example, the input detection portion 70 may detect an input of a door opening command for opening the second door 40.

The input detection portion 70 may be provided at the second door 40, for example, In a case in which the second door 40 is received in the first opening 32 of the first door 30, the input detection portion 70 may also be provided at the first door 30.

The input detection portion 70 may be installed on the door body or the front panel 432. For example, the input detection portion 70 may be installed on a rear surface of the front panel 432 by, for example, an adhesive means 79. The input detection portion 70 may be positioned at an extension in the front panel 432. The input detection portion 70 may be positioned at an extension 432a extending outward from the front panel 432 to an outside of the door than the insulation panel 434.

The input detection portion 70 may be a touch sensor that detects a user's touch on the front panel 432, or a knock sensor that detects multiple knocks on the front panel 432. For example, the input detection portion 70 may be a capacitance sensor, a sensor that detects vibration, or a sensor that detects sound waves.

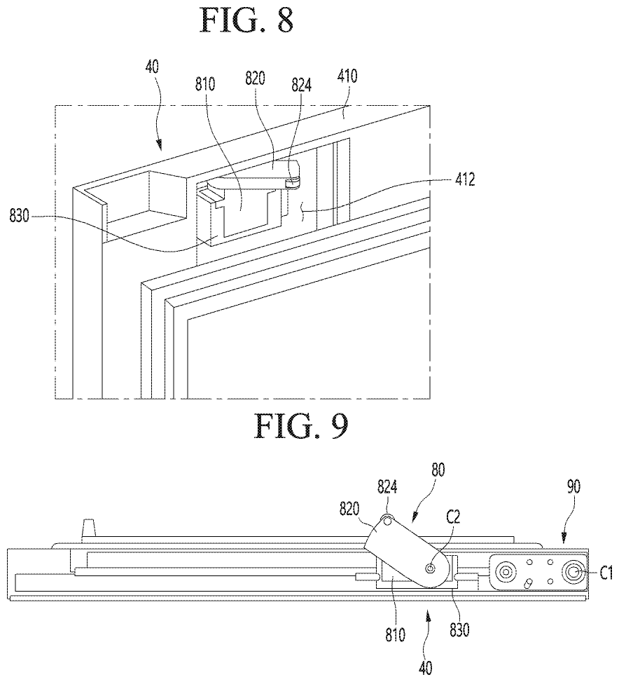

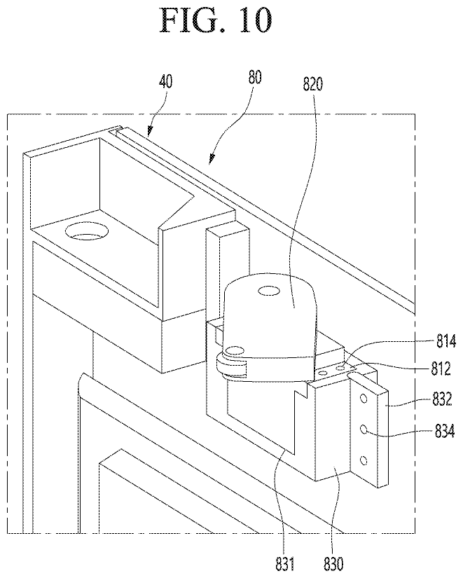

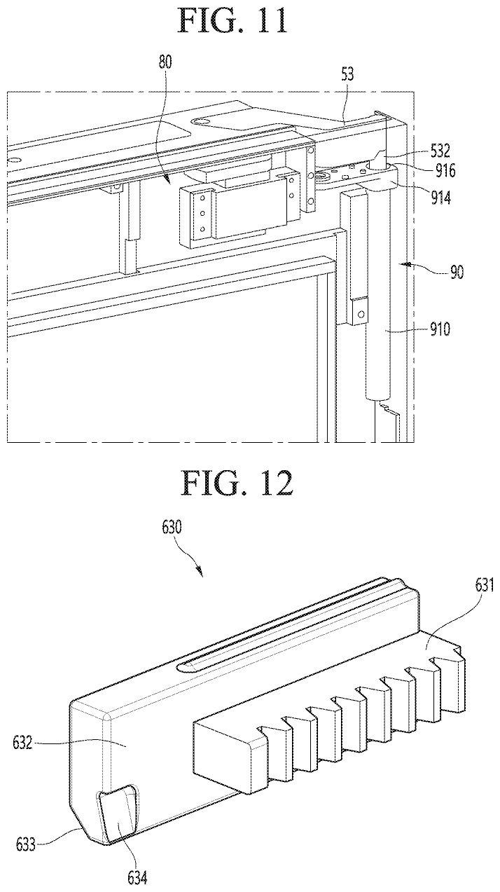

FIG. 7 is a drawing partially showing a state in which a second door is opened according to an embodiment of the present invention. FIG. 8 is a drawing showing a door opening device provided in the second door. FIG. 9 is a plan view showing a state in which a door opening portion protrudes from a second door. FIG. 10 is a drawing showing a position of a door opening device in a second door. FIG. 11 is a drawing showing a door opening device and an auto closing unit in a second door.

Referring to FIGS. 7 to 11, the second door 40 may be provided with a door opening device 80 to automatically open the second door 40. The second door 40 may be rotated by the door opening device 80 to open the first opening 32.

The body frame 410 or the door liner 420 may be provided with a receiving portion 412 for receiving the door opening device 80. The receiving portion 412 may be formed, for example, by being recessed from a rear surface of the second door 40 toward a front surface.

In a state in which the door opening device 80 is received in the receiving portion 412, the receiving portion 412 may be covered by a receiving portion cover 450. For example, the receiving portion cover 450 may be coupled to a rear surface of the second door 40.

The door opening device 80 may include a second driver 810. The door opening device 80 may further include a door opening portion 820 operated by the second driver 810.

The second driver 810 may include a motor. The door opening portion 820 may be connected to the motor. Alternatively, the second driver 810 may include a motor and one or more gears connected to the motor. The door opening portion 820 may be connected to the one or more gears.

The door opening portion 820 may, for example, be rotated. A thickness of the second door 40 may be less than that of the first door 30. The door opening portion 820 may rotate so that the second door 40 may be opened by an operation of the door opening portion 820.

The second driver 810 may be disposed at a lower side of the door opening portion 820.

The door opening portion 820 may include a contact portion 824 in contact with a front surface of the first door 30 during a door opening process. The contact portion 824 may, for example, be a roller that is rotatably connected to one end of the door opening portion 820.

A through hole 452 may be formed in the receiving portion cover 450. The door opening portion 820 may pass through the through hole 452. Alternatively, the through hole 452 may be formed on a rear surface of the second door 40 regardless of the receiving portion cover 450.

The door opening portion 820 may move from an initial position to a door opening position. In a state in which the door opening portion 820 is positioned at the initial position, the contact portion 824 may be positioned at the through hole 452 or the receiving portion 412.

By a rotational operation of the door opening portion 820, the door opening portion 820 may protrude from the second door 40 by passing through the through hole 452. To enable the door opening portion 820 to protrude by passing through the through hole 452, a horizontal length of the through hole 452 may be greater than a height (or a length in a vertical direction).

The door opening device 80 may include a mounting bracket 830 on which the second driver 810 is mounted. The second driver 810 may include a coupling hole 812 for being coupled to the mounting bracket 830.

The mounting bracket 830 may include a slot 831 in which the second driver 810 is received. The mounting bracket 830 may further include a coupling portion 832 coupled to the door body. The coupling portion 832 may extend from the mounting bracket 830 in a horizontal direction. One or more coupling holes 834 may be formed in the coupling portion 832. The mounting bracket 830 may be received in the receiving portion 412 in a horizontal direction. By changing a position or shape of the receiving portion 412, the mounting bracket 830 may be received in the receiving portion 412 in a vertical direction.

The second door 40 may be provided with a hinge mounting portion 418 on which the second hinge 53 is mounted. The hinge mounting portion 418 may be formed by an upper surface of the second door 40 being recessed downward or by a rear surface of the second door 40 being recessed toward a front surface.

A rotation center C2 (or center line) of the door opening portion 820 may extend in the vertical direction. Therefore, a rotation center C2 (or center line) of the door opening portion 820 may be parallel to a rotation center C1 (or center line) of the second door 40.

At an initial position of the door opening portion 820, the contact portion 824 may be positioned closer to a front surface of the first door 30 or a rear surface of the second door 40 than a rotation center C2 of the door opening portion 820.

At an initial position of the door opening portion 820, the contact portion 824 may be positioned closer to a front surface of the first door 30 or a rear surface of the second door 40 than a rotation center C1 of the second door 40.

The second door 40 may further include an auto closing unit 90 to automatically close the second door 40 when the second door 40 is opened less than a reference angle.

A door opening angle of the second door 40 opened by the door opening portion 820 may be less than the reference angle. Accordingly, when the second door 40 is opened by the door opening portion 820 by the door opening angle, but the user does not additionally open the second door 40, and the door opening portion 820 returns to an initial position, the second door 40 may be automatically closed by the auto closing unit 90.

The auto closing unit 90 may include a first body 910 that has an elastic member received therein and extends in a vertical direction, and a second body 914 provided at one side of the first body 910 and coupled to the second door 40. A shaft 532 of the second hinge 53 may pass through an opening 916 of the second body 914. The shaft 532 may be directly connected to an elastic member of the first body 910 or may be connected to the elastic member by a separate connector.

A wire for connecting the second driver 810 and the input detection portion 70, the proximity sensor 71, etc. may pass through the shaft 532.

At an initial position of the door opening portion 820, a rotation center C2 of the door opening portion 820 may be positioned between the contact portion 824 and a rotation center C1 of the second door 40. In this case, when the door opening portion 820 rotates, a length of the door opening portion 820 may be increased without interfering with the second hinge 53.

As the door opening portion 820 moves from an initial position to a door opening position, a distance between the contact portion 824 and a rotation center CI of the second door 40 may be decreased.

The second body 914 may be positioned lower than a bottom of the hinge mounting portion 418, and the door opening portion 820 may be positioned higher than a bottom of the hinge mounting portion 418. Accordingly, the door opening portion 820 may be prevented from interfering with the auto closing unit 90.

FIG. 12 is a perspective view of the locking portion of the present embodiment.

Referring to FIG. 12, a locking portion 630 of the present embodiment may include a rack gear 631 to transfer power from the transfer portion 620. The rack gear 631 may, for example, extend in a horizontal direction.

The locking portion 630 may further include a protrusion 632 (or locking protrusion) for insertion into the groove 424. A recess 634 may be formed in the protrusion 632. A portion of the latch portion 470 may be inserted into the recess 634.

In this embodiment, a position to which the locking portion 630 is moved to be inserted into the groove 424 may be referred to as a locking position. A position to which the locking portion 630 is moved to be removed from the groove 424 may be referred to as an unlocking position.

The protrusion 632 may further include an inclined portion 633. The inclined portion 633 may be positioned opposite the recess 634. The inclined portion 633 may be in contact with the latch portion 470 while the second door 40 is manually opened and then closed, thereby allowing the latch portion 470 to rotate.

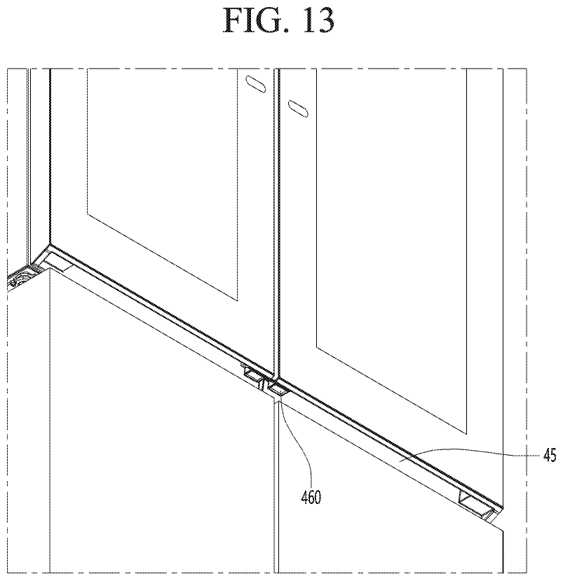

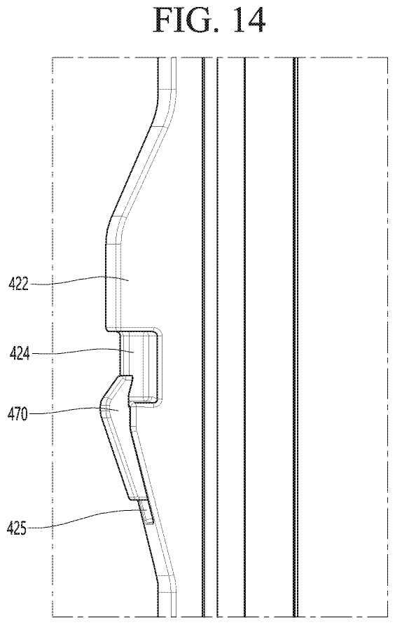

FIG. 13 is a drawing showing a second door viewed from a lower side in a state in which first and second doors are closed. FIG. 14 is a perspective view showing a latch portion provided at an extension of a second door.

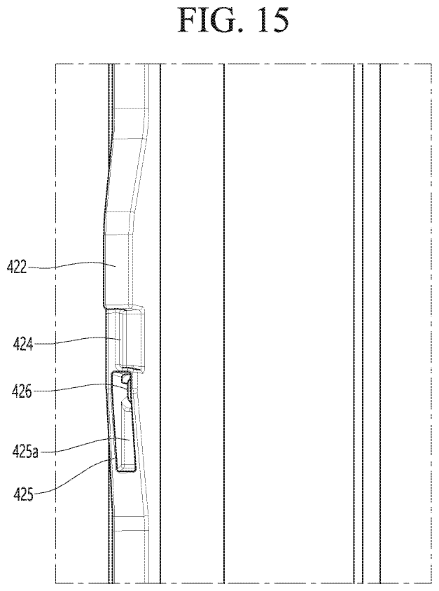

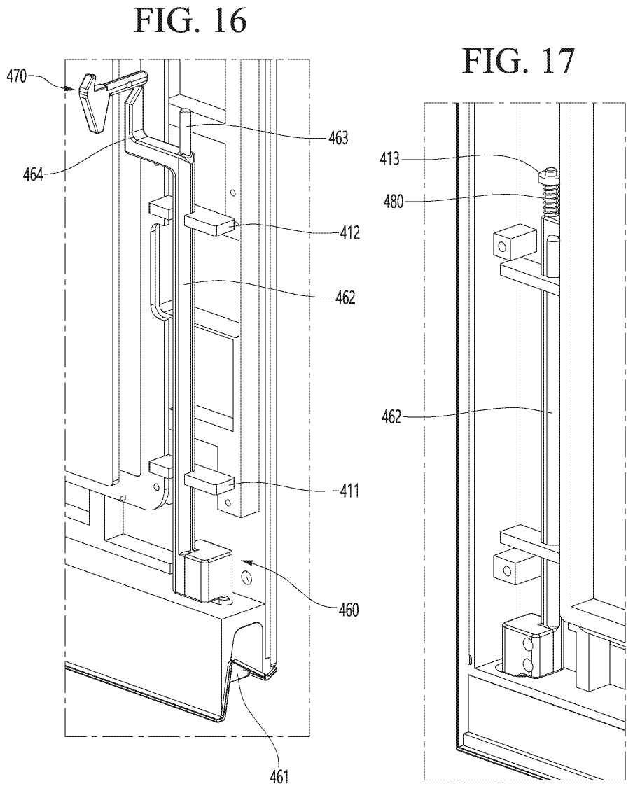

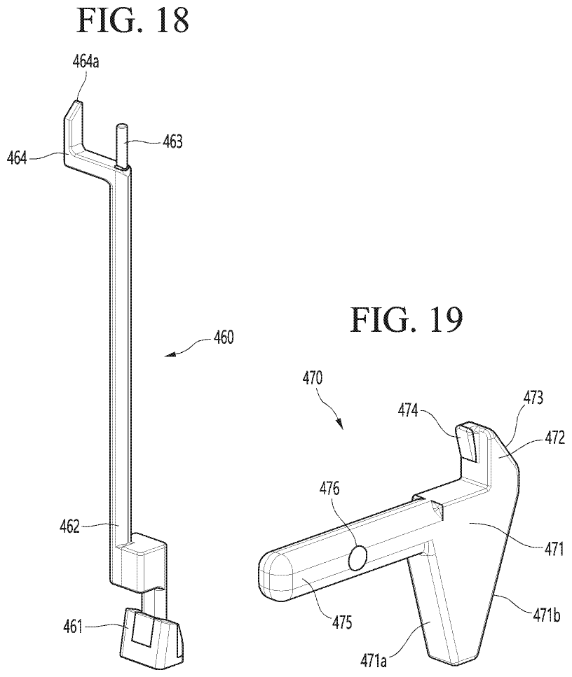

FIG. 15 is a perspective view showing a latch portion removed from an extension of a second door. FIG. 16 is a drawing showing a latch portion and manipulating portion installed at the second door. FIG. 17 is a drawing showing a state in which a manipulating portion is installed at the second door. FIG. 18 is a perspective view of a manipulating portion according to the present embodiment. FIG. 19 is a perspective view of a latch portion according to the present embodiment.

Referring to FIGS. 13 to 19, a handle 45 may be provided at a lower side of the second door 40. A user may grasp the handle 45 to rotate the second door 40. The first door 30 may not be provided with a handle. Of course, it is also possible for the first door 30 to be provided with a handle.

When the first door 30 and the second door 40 are closed, the first door 30 and the second door 40 may be in a locking state. In this state, when the user pulls the second door 40 while gripping the handle 45 of the second door 40, the first door 30 may be rotated together with the second door 40.

Since an opening of the first door 30 and an opening of the second door 40 are possible by using the handle 45 of the second door 40, the user can easily open the first door 30 or the second door 40 while gripping the handle 45.

If the handle is not formed at the first door 30, there is an advantage in that a structure of the first door 30 becomes simple. In addition, since the first door 30 is disposed at a rear side of the second door 40, there is an advantage in that the user does not have to move his hand to a lower side of the first door 30.

The second door 40 may further include a manipulating portion 460 to move the latch portion 470.

In a non-manipulated state of the manipulating portion 460, the latch portion 470 is positioned at an initial position. When the latch portion 470 is positioned at the initial position, in a locking state of the second door 40, a rotation of the second door 40 is restricted.

However, in the case in which a power supplied to the refrigerator 1 is cut off, such as a power outage, etc., a locking state of the first door 30 and the second door 40 is maintained, so there is a disadvantage in that the second door 40 cannot be opened.

Even if the power supplied to the refrigerator 1 is cut off, there is a need to take out a food stored in the first door 30. However, if the second door 40 cannot be opened, there is an inconvenience in having to open the first door 30 to take out the food.

In the present embodiment, even if the power supplied to the refrigerator 1 is cut off and the locking device cannot be operated, the second door 40 can be rotated by operating the manipulating portion 460 to move the latch portion 470 from the initial position to an unhooking position. That is, when the manipulating portion 460 is operated in a locking state of the first door 30 and the second door 40, the second door 40 can be opened.

A portion of the manipulating portion 460 may be positioned to be exposed to the handle 45. For example, a portion of the manipulating portion 460 may protrude into an inner space of the handle 45, and another portion may be positioned inside the second door 40.

Within the handle 45, the manipulating portion 460 may be positioned adjacent to the extension 422 in a vertical direction. In this case, a transfer path for an manipulating force of the manipulating portion 460 to be transferred to the latch portion 470 may be reduced.

A groove 424 for receiving the protrusion 632 may be formed in the above extension 422. A receiving portion 425 for receiving the latch portion 470 may be provided at one side of the groove 424. For example, the receiving portion 425 may be positioned at a lower side of the groove 424. As another example, the receiving portion 425 may be positioned at an upper side of the groove 424.

The above groove 424 may be formed by being recessed in a first surface of the extension 422. The receiving portion 425 may be formed by being recessed in a second surface crossing the first surface of the extension 422. In another aspect, the groove 424 may be recessed in the first surface of the extension 422, and the receiving portion 425 may also be recessed in the first surface of the extension 422.

A slot 426 may be formed in the receiving portion 425 through which a portion of the latch portion 470 passes.

The latch portion 470 may include a first portion 471. A portion of the first portion 471 may be received in the receiving portion 425. Another portion of the first portion 471 may protrude outward from the receiving portion 425.

A hook portion 472 for hooking with one side of the protrusion 632 may be formed in the first portion 471.

The hook portion 472 may be positioned at an upper side of the first portion 471 based on the drawing. A protrusion 474 (or a hooking protrusion) that is inserted into the recess 634 of the protrusion 632 may be formed on the hook portion 472.

The hook portion 472 may cover a portion of the groove 424 at an outside of the receiving portion 425.

In a state in which the hook portion 472 is hooked with the locking portion 630, a portion of the locking portion 630 may be positioned between a portion of the hook portion 472 and a front side (or front panel) of the second door 40.

An inclined surface 473 may be formed on the hook portion 472. Based on the hook portion 472, the inclined surface 473 may be formed at an opposite side of the protrusion 474.

At a locking position of the locking portion 630, when the second door 40 is manually opened and then closed again, the inclined surface 473 may be in contact with the inclined surface 633 of the protrusion 632.

The first portion 471 may be formed so that a width decreases as going downward. For example, the first portion 471 may include a first inclined surface 471a.

The first portion 471 may further include a second inclined surface 471b. The hook portion 472 may extend from a position adjacent to the second inclined surface 471b.

A distance between the first inclined surface 471a and the second inclined surface 471b may decrease as going downward. Alternatively, depending on a position of the latch portion 470, a distance between the first inclined surface 471a and the second inclined surface 471b may also decrease as going upward.

The first inclined surface 471a may be positioned within the receiving portion 425. The first inclined surface 471b may be positioned at an outside of the receiving portion 425.

At an initial position of the latch portion 470, at least a portion of the first inclined surface 471a may be spaced apart from a recess surface 425a of the receiving portion 425.

In a process of the latch portion 470 moving to an unhooking position, the first inclined surface 471a moves in a direction closer to the recess surface 425a. If at least a portion of the first inclined surface 471a is spaced apart from the recessed surface 425a of the receiving portion 426, interference between the first inclined surface 47la and the recessed surface 425a can be prevented.

When the second inclined surface 471b is located at an outside of the receiving portion 425, a size of the portion protruding from the latch portion 470 to the outside of the receiving portion 425 is reduced, so that interference with surrounding structures can be prevented when the second door 40 is closed.

The latch portion 470 may further include a second portion 475 extending from the first portion 471. Based on the drawing, the second portion 475 may extend from the first portion 471 in a horizontal direction.

The second portion 475 may be introduced into the second door 40 after passing through the slot 426.

A pin hole 476 may be formed in the second portion 475. A pin (not shown) may be provided inside the second door 40, and the second portion 475 may be rotatably supported by the second door 40 by the pin.

The manipulating portion 460 may be installed movably within the second door 40. For example, the manipulating portion 460 may be installed so as to be able to move up and down.

The door frame 410 or the door liner 420 may be provided with guide portions 411 and 412 for guiding an up and down movement of the manipulating portion 460. When the manipulating portion 460 is provided in the second door 40, the manipulating portion 460 may be positioned in a space partitioned from a space in which an insulator provided in the second door 40 is positioned.

The manipulating portion 460 may include a pressing portion 461 for a user to press. The pressing portion 461 may be positioned at the handle 45.

The manipulating portion 460 may further include an extension 463 extending from the pressing portion 461. The extension 463 extends upward from the pressing portion 461, and an up and down movement may be guided by the guide portions 411 and 412.

The manipulating portion 460 may further include a transfer portion 464 extending from the extension 463. The transfer portion 464 may be in contact with the latch portion 470.

The transfer portion 464 may include, for example, a first part extending in a horizontal direction and a second part extending upward from the first part, but a shape is not limited thereto.

The transfer portion 464 may include a contact end 464a that contacts the latch portion 470.

The first portion 471 is positioned at one side of the second portion 475, and the contact end 464a may, for example, be in contact with another side positioned at an opposite side of the first portion 471 based on the pin hole 476 at the second portion 475.

The manipulating portion 460 may further include a first supporter 463 to support an elastic member 480. For example, the first supporter 463 may extend from the extension 462. In a case in which the elastic member 480 is, for example, a coil spring, the first supporter 463 may be inserted into an internal space of the coil spring, and one end of the coil spring may be seated on the extension 462. The door frame 410 or the door liner 420 may be provided with a second supporter 413 that supports another side of the elastic member 480.

For example, another end of the coil spring may be in contact with the second supporter 413. The first supporter 463 may, for example, pass through the second supporter 413.

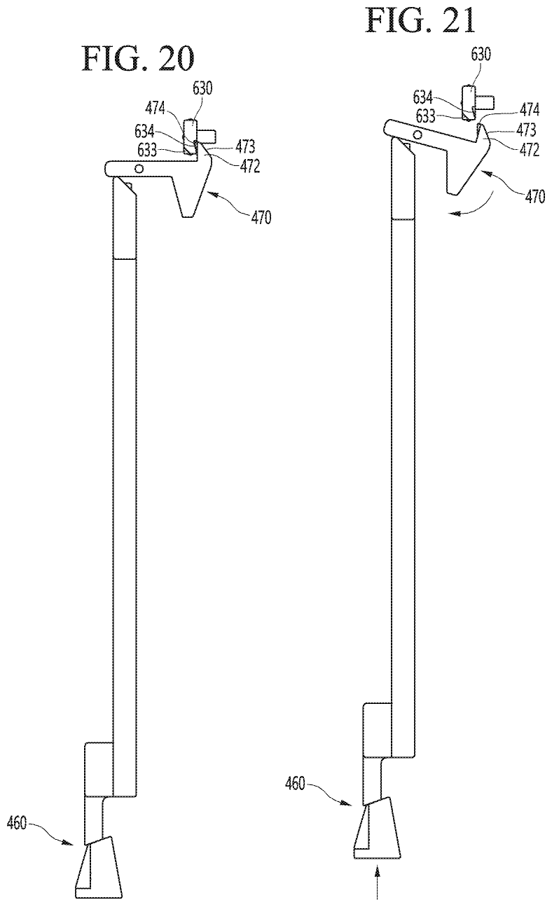

FIG. 20 is a drawing showing a state of a latch portion, a locking portion, and a manipulating portion when the latch portion is positioned at an initial position. FIG. 21 is a drawing showing a state when a manipulating portion is manipulated and a latch portion is moved to an unhooking position.

Referring to FIGS. 20 and 21, at a locking position of the locking portion 630, the manipulating portion 460 may be manipulated to manually open the second door 40.

For example, the manipulating portion 460 may be pressed upward.

The second door 40 may be manually opened by manipulating the manipulating portion 460 not only when a power to refrigerator 1 is cut off, but also when power is supplied to refrigerator 1.

When the manipulating portion 460 is manipulated, for example, by pressing the manipulating portion 460 upward, the manipulating portion 460 may rise.

When the manipulating portion 460 rises, the contact body 464a raises another side of the second portion 475, so that the second portion 475 may be rotated. When the second portion 475 is rotated, the first portion 471 positioned at one side of the second portion 475 is lowered. Accordingly, the latch portion 470 moves from an initial position to an unhooking position. In this specification, a direction in which the latch portion 470 moves from the initial position to the unhooking position may be referred to as a first direction. A direction in which the latch portion 470 moves from the unhooking position to the initial position may be referred to as a second direction.

When the first portion 471 is lowered, the protrusion 474 may be fall out of the recess 634. In addition, when the first portion 471 is lowered, an upper end of the hook portion 472 may be positioned lower than a lower end of the protrusion 632. In this state, when the handle 45 is held and the second door 40 is opened, a rotation of the second door 40 is possible without interference of the protrusion 632 and the latch portion 470.

A movement of the latch portion 470 from the initial position to the unhooking position means that the latch portion 470 moves to a position where interference with the locking portion 630 is prevented.

Meanwhile, when a force applied to the manipulating portion 460 is removed after the second door 40 is opened, the manipulating portion 460 is lowered by the elastic force of the elastic member 480. The latch portion 470 moves in the second direction from the unhooking position to the initial position.

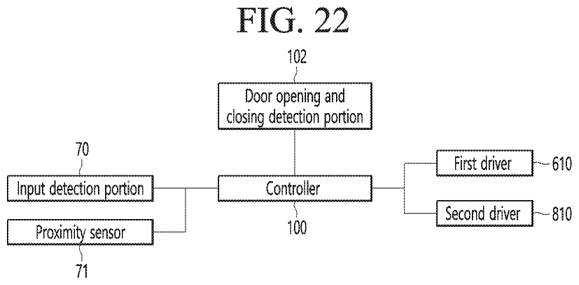

FIG. 22 is a control block diagram of a refrigerator according to an embodiment of the present invention.

Referring to FIG. 22, the refrigerator 1 may further include a proximity sensor 71 that detects a user's approach to the refrigerator 1.

The proximity sensor 71 may be provided at the second door 40, for example. When a user approaches the second door 40 within a reference distance, the input detection portion 70 may be activated.

In a case in which the second door 40 is received in the first opening 32 of the first door 30, the proximity sensor 71 may also be provided at the first door 30.

If the proximity sensor 71 is provided at the second door 40, the input detection portion 70 may be prevented from being unnecessarily activated by a child or a pet.

Of course, the proximity sensor 71 may be omitted, and in this case, the input detection portion 70 may also be maintained in an activated state.

When the proximity sensor 71 detects that a user is approaching the second door 40 within a reference distance, a light emitting portion (not shown) may irradiate light toward the input detection portion 70 or irradiate light around the input detection portion 70. Alternatively, the input detection portion 70 may include a light emitting portion.

A user can easily check a position of the input detection portion 70 by the light irradiated by the light emitting portion.

If the first door 30 may also be opened automatically, the second door 40 may also be provided with two input detection portions 70. That is, when a user approaches the second door 40 within a reference distance, two input detection portions 70 may be activated, and the user may select a door to be opened and input a door opening command.

The refrigerator may further include a controller 100.

The controller 100 may control one or more of the locking device 60 and the door opening device 80. For example, the controller 100 may control the first driver 610 and the second driver 810.

In this specification, the controller 100 may be a single controller or may include a first controller and a second controller that are configured separately. That is, the first controller may control the first driver 610, and the second controller may control the second driver 810.

For example, the controller 100 may control the first driver 610 and the second driver 810.

The refrigerator may further include a door opening and closing detection portion 102. The door opening and closing detection portion 102 may detect a closing of the second door 40.

The door opening and closing detection portion 102 may detect that the second door 40 is opened by a limit angle greater than the door opening angle.

In a state in which the second door 40 is opened to the door opening angle, the second door 40 must be manually rotated in an opening direction by the user so that the second door 40 can be opened beyond the limited angle.

The controller 100 may operate the first driver 610 so that the first door 30 and the second door 40 are in a locking state when a closing of the second door 40 is detected by the door opening and closing detection portion 102.

As another example, the door opening and closing detection portion 102 may include a first detection portion that detects a closing of the second door 40. The door opening and closing detection portion 102 may include a second detection portion that detects that the second door 40 is opened beyond a limited angle. The first detection portion and the second detection portion may be the same type of sensor or different types of sensors.

The controller 100 may operate the first driver 610 so that the first door 30 and the second door 40 are in an unlocking state when an input of a door opening command from a user is detected by the input detection portion 70 in a state in which the second door 40 is closed and the first door 30 and the second door 40 are in a locking state.

The controller 100 may operate the second driver 810 so that the second door 40 is opened by the door opening portion 820 after an input of a door opening command from a user is detected by the input detection portion 70 (for example, a rotation of a motor in a forward direction).

The controller 100 may operate the second driver 810 so that the door opening portion 820 moves from a door opening position to the initial position when the second door 40 is detected to be opened beyond a limited angle by the door opening and closing detection portion 102 after the second driver 810 operates (for example, a rotation of a motor in a reverse direction).

Hereinafter, an operation of the locking device and the door opening device will be described.

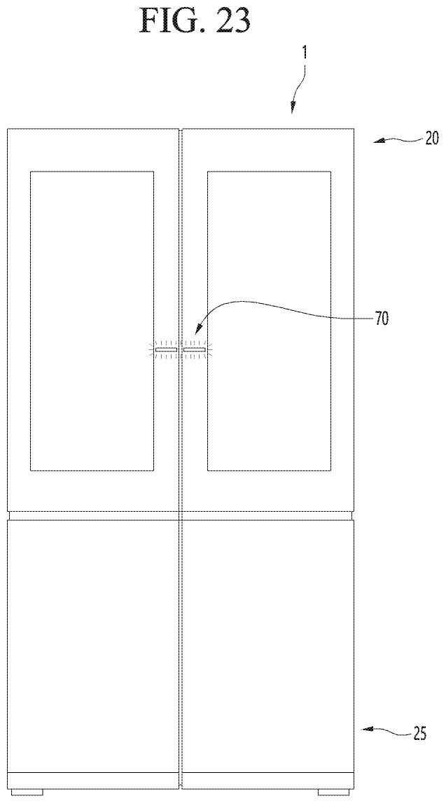

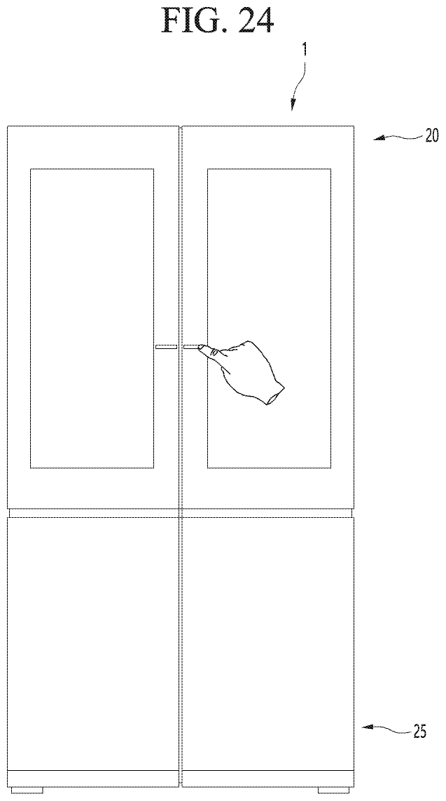

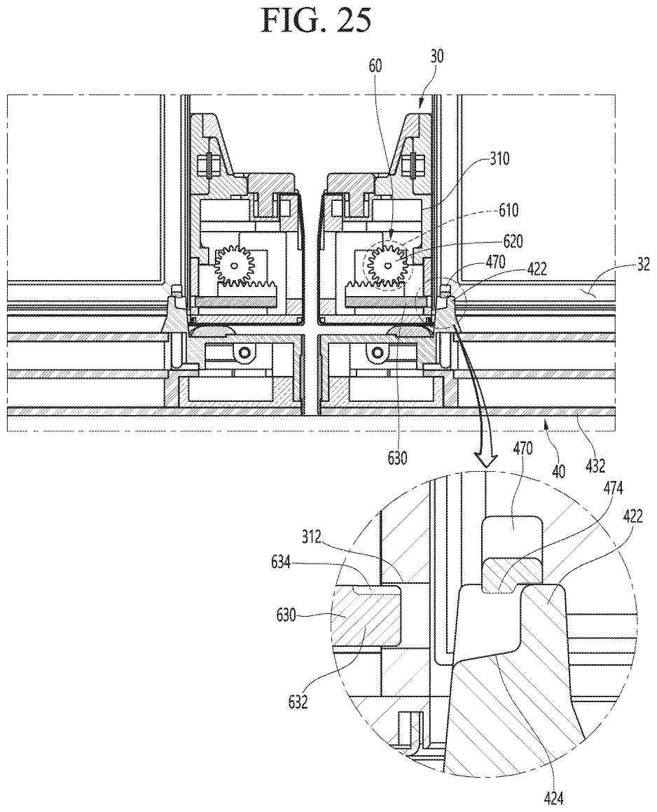

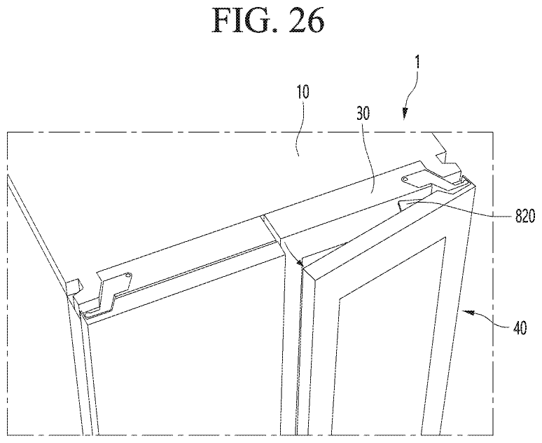

FIG. 23 is a diagram showing a state in which an input detection portion is activated when a user approaches a refrigerator within a reference distance. FIG. 24 is a drawing showing a user inputting a door opening command into an input detection portion. FIG. 25 is a drawing showing first and second doors being unlocked by a locking device. FIG. 26 is a drawing showing a state in which a second door is opened by a door opening device at a door opening angle.

Referring to FIGS. 23 to 26, when it is detected that a user has approached a refrigerator 1 within a reference distance, the input detection portion 70 of each of the first and second refrigerating chamber doors 21 and 22 may be activated. As described above, light may be irradiated to the input detection portion 70 or may be irradiated to surroundings of the input detection portion 70 by an operation of the light emitting portion.

Alternatively, when it is detected that a user has approached a refrigerator 1 within a reference distance by at least one the proximity sensor 71 of the first and second refrigerating chamber doors 21 and 22, the input detection portion 70 of the refrigerating chamber door provided with the at least one proximity sensor 71 may be activated.

Referring to FIG. 25, for example, when a user touches an area corresponding to the input detection portion 70 in the second door 40, it can be detected that a door opening command has been input in the input detection portion 70. Of course, depending on a type of the input detection portion 70, it is also possible to detect that a door opening command has been input by knocking on a front surface of the second door 40 more than twice.

In a state in which the second door 40 is closed, the second door 40 and the first door 30 may be maintained in a locking state by the locking device 60.

Meanwhile, if an input of a door opening command is not detected within an input reference time after the input detection portion 70 is activated, the input detection portion 70 may be deactivated. For example, the light emitting portion may also be turned off. In addition, if a user is not detected by the proximity sensor 71 before an input reference time elapses after the input detection portion 70 is activated, the input detection portion 70 may be deactivated.

Referring to FIG. 26, when a door opening command is detected to be input in the input detection portion 70, the first driver 610 may be operated by the controller 100 (a rotation of a motor in one direction). Then, the locking portion 630 moves in one direction so that a protrusion 632 of the locking portion 630 is withdrawn from a groove 424 of the extension 422 of the second door 40. Additionally, the protrusion 474 of the latch portion 470 may be withdrawn from the recess 634.

Accordingly, the first door 30 and the second door 40 may be in an unlocking state. After the first door 30 and the second door 40 are in an unlocking state, the second driver 810 may be operated to open the second door 40 (a rotation of a motor in a forward direction).

For example, after the first driver 610 operates and a set time has elapsed, the second driver 810 may operate.

As shown in FIG. 26, when the second driver 810 operates, the door opening portion 820 rotates so that the door opening portion 820 protrudes toward the first door 30 and pushes the first door 30. In a process of the door opening portion 820 pushing the first door 30, the second door 40 may be rotated.

After the first door 30 and the second door 40 are in an unlocking state, the second door 40 becomes capable of rotating, so that the second door 40 may be automatically opened by an operation of the second driver 810 or may be manually opened by the user.

By an operation of the second driver 810, the door opening portion 820 may be moved from an initial position to a door opening position. When the door opening portion 820 is moved to the door opening position, the second door 40 may be opened by the door opening angle.

When the door opening portion 820 is moved to the door opening position, the second driver 810 may be stopped. In this case, the second door 40 may be maintained in an opened state by the door opening angle.

When the second driver 810 is stopped and a set time has elapsed, the second driver 810 operates to move the door opening portion 820 from the door opening position to the initial position (a rotation of a motor in a reverse direction).

In a state in which the second door 40 is opened by the door opening angle, if the second door 40 is not manually opened additionally by the user and the set time has elapsed, the door opening portion 820 may be moved from the door opening position to the initial position by the second driver 810. In this case, the second door 40 may be automatically closed by the auto closing unit 90. When the second door 40 is automatically closed, the door opening and closing detection portion 102 detects a closing of the second door 40. In this case, the first door 30 and the second door 40 are locked by an operation of the first driver 610. That is, a protrusion 632 of the locking portion 630 may be inserted into a groove 424 of the second door 40.

Meanwhile, in order to open the second door 40, while the second driver 820 is operating or while the door opening portion 820 is moved to the door opening position, the user can manually further open the second door 40. In this case, the door opening and closing detection portion 102 may detect that the second door 40 is opened beyond the limited angle. Then, the controller 100 may control the second driver 810 so that the door opening portion 820 returns to the initial position.

The second door 40 may be manually closed by a user, and when a closing of the second door 40 is detected, the controller 100 may operate the first driver 610 so that the first door 30 and the second door 40 are in a locking state (a rotation of a motor rotation in another direction).

Meanwhile, when the manipulating portion 460 is operated in a locked state of the first door 30 and the second door 40, the latch portion 470 moves to an unhooking position where interference with the locking portion 630 is released, so that the second door 40 may be manually opened.

When the second door 40 is closed again in a state in which the second door 40 is manually opened, the latch portion 470 is positioned at a locking position, so that the inclined surface 473 of the latch portion 470 may be in contact with the inclined portion 633 of the protrusion 632.

In this state, if the second door 40 is additionally rotated in a closing direction, the latch portion 470 may be rotated in the first direction.

After the latch portion 470 is rotated in the first direction, an upper end of the hook portion 472 moves along a lower end of the protrusion 632, and when the second door 40 is completely closed, the latch portion 470 is rotated in the second direction and returns to an initial position. That is, the protrusion 474 is inserted into the recess 634.

Meanwhile, it is possible to move the locking portion 630 to be an unlocking state in a state in which the latch portion 470 is positioned at the initial position, and in this process, the protrusion 474 falls out of the recess 634 of the locking portion 630.

Since the recess 634 is formed at an end of the protrusion 634, even when the protrusion 474 is inserted into the recess 634, the locking portion 630 may move to the unlocking position without interference with the protrusion 474.

According to this embodiment, there is an advantage in that automatic opening of the second door disposed at an outside of the first door is possible.

In addition, when the input detection portion is activated when a proximity of the user is detected, there is an advantage in that the input detection portion is prevented from being activated unnecessarily.

Since the second door and the first door are in a locked state when the second door is closed, there is an advantage in that the first door can be opened. In addition, since a handle for opening the first door is the same as a handle for opening the second door, there is an advantage in that two separate handles are unnecessary.

In addition, even when a power supplied to the refrigerator is cut off, such as a power outage, there is an advantage in that the second door may be manually opened by operating the manipulating portion.

In addition, even if the locking device is broken or malfunctions, there is an advantage in that manual opening of the second door is possible by operating the manipulating portion.

Meanwhile, each of the first and second refrigerating chamber doors 21 and 22 may be provided with a lighting unit. In this case, there is an advantage in that it is possible to check items stored in each of the first and second refrigerating chamber doors 21 and 22 without opening the second door.

In the above embodiment, the door opening device is described as being provided in the second door, but it is to be noted that it may be provided in the first door. For example, it is also possible for the door opening portion to protrude from the first door and push the second door to open the second door.

In addition, when the receiving portion 425 is positioned at an upper side of the groove 424, a shape of the latch portion 470 may also be changed, and a rotation direction of the latch portion 470 by manipulation of the manipulating portion 460 may be opposite to that described above.

1. A refrigerator comprising:
a cabinet having storage space;
a first door that opens and closes the storage space and including an opening;
a second door that opens and closes the opening and is rotatable relative to the first door;
a locking device that allows the first door and the second door to be in a locking state or an unlocking state in a state in which the second door is closed;
a door opening device configured to automatically open the second door; and
a controller configured to control the door opening device.

2. The refrigerator of claim 1,
wherein the locking device includes a locking portion provided at the first door, and
wherein the second door includes a latch portion that is hooked with the locking portion in a state in which the locking portion is positioned at a locking position, and
a manipulating portion configured to move the latch portion to an unhooking position where the latch portion is unhooked from the locking portion.

3. The refrigerator of claim 2,
wherein the second door includes a handle and the manipulating portion is exposed to the handle.

4. The refrigerator of claim 3,
wherein when the handle is pulled in a locking state of the first door and the second door, the first door is opened,
when the handle is pulled after operating the manipulating portion in the locking state of the first door and the second door, the second door is opened, and
when the handle is pulled in an unlocking state of the first door and the second door, the second door is opened.

5. The refrigerator of claim 2,
wherein the second door includes a groove into which the locking portion is inserted at a locking position of the locking portion, and
wherein the latch portion forms a portion of the groove, or a portion of the latch portion covers the groove in a state in which the latch portion is hooked with the locking portion.

6. The refrigerator of claim 2,
wherein in a state in which the locking portion is positioned at the locking position, when the manipulating portion is manipulated in one direction, the latch portion is rotated in a first direction and moved to the unhooking position.

7. The refrigerator of claim 2,
wherein the locking portion includes a recess, and
wherein the latch portion includes a hook portion to be hooked with the locking portion and a protrusion is formed on the hook portion to be inserted into the recess.

8. The refrigerator of claim 7,
wherein when the latch portion moves to the unhooking position, the protrusion is withdrawn from the recess, and the latch portion is spaced apart from the locking portion.

9. The refrigerator of claim 7,
wherein an inclined surface is formed at an opposite side of the protrusion in the hook portion, and
wherein an inclined portion is formed at an opposite side of the recess in the locking portion.

10. The refrigerator of claim 2,
wherein the latch portion includes a first portion in which a hook portion to be hooked with the locking portion is formed, and a second portion extending from the first portion and rotatably supported by the second door.

11. The refrigerator of claim 10,
wherein the second door includes a receiving portion that receives a portion of the first portion, and
wherein a slot through which the second portion passes is formed in the receiving portion.

12. The refrigerator of claim 11,
wherein the first portion includes a first inclined surface received in the receiving portion, and
wherein at least a portion of the first inclined surface is spaced apart from a recessed surface of the receiving portion in a state in which the hook portion is hooked with the locking portion.

13. The refrigerator of claim 12,
wherein while the latch portion moves to the unhooking position, the first inclined surface moves closer to the recessed surface.

14. The refrigerator of claim 12,
wherein the first portion further includes a second inclined surface positioned outside the receiving portion, and
wherein a distance between the first and second inclined surfaces is decreased downward.

15. The refrigerator of claim 2,
wherein the locking device further includes a first driver, and
wherein the locking portion is operated by receiving a power from the first driver,
the first door is provided with a hole through which the locking portion passes, and
the locking portion is inserted into a groove of the second door by passing through the hole.

16. The refrigerator of claim 15,
wherein the second door includes an extension positioned in the opening when the second door is closed, and
wherein the extension is provided with the latch portion and a groove into which the locking portion is inserted.

17. The refrigerator of claim 16,
wherein in a state in which the latch portion is hooked with the locking portion, the locking portion is positioned between a portion of the latch portion and a front surface of the second door.

18. The refrigerator of claim 1, further comprising an input detection portion that detects an input of an opening command for the second door,
wherein when the input detection portion detects an input of an opening command for the second door, the locking device is controlled so that the first door and the second door are in an unlocking state, and
the controller is configured to operate the door opening device to open the second door when the first door and the second door are in an unlocking state.

19. The refrigerator of claim 18,
further comprising a door opening and closing detection portion that detects a closing of the second door, and
wherein when the closing of the second door is detected by the door opening and closing detection portion, the locking device is controlled so that the first door and the second door are in a locking state.

20. The refrigerator of claim 1,
wherein the door opening device includes:
a second driver, and
a door opening portion that operates by receiving power from the second driver and pushes the first door or the second door during an opening process of the second door.
